(19) United States
(12) Patent Application Publication
(10) Pub. No.: US 2026/0229948 A1
(43) Pub. Date: Aug. 6, 2026

(54) A STATOR ASSEMBLY

(71) Applicant: Dyson Technology Limited, Malmesbury, Wiltshire (GB)

(72) Inventors: Christopher James GASKELL, Swindon (GB); Harry Alexander MORLEY, Bristol (GB); Pau MIQUEL MIR, Berlin (DE); Chukwuma Junior IFEDI, Bristol (GB); Xiaoxu ZHANG, Bristol (GB); Tuncay CELIK, Malmesbury (GB); Andrew Charlton CLOTHIER, Chippenham (GB); Yu CHEN, Cheltonham (GB)

(21) Appl. No.: 19/148,812

(22) PCT Filed: Jan. 26, 2024
(86) PCT No.: PCT/IB2024/050738

§ 371 Date: Jul. 17, 2025

(30) Foreign Application Priority Data
Jan. 27, 2023 (GB) 2301189.3

(51) Int. Cl. H02K 3/52

(52) U.S. Cl. CPC H02K 3/522

(57) ABSTRACT

A stator assembly for a brushless permanent magnet motor includes a stator core, a plurality of coils wound around the stator core, and a plurality of termination connections to which the plurality of coils are connected. A first subset of the plurality of termination connections are located at a first end of the stator assembly, and a second subset of the plurality of termination connections, different to the first subset of the plurality of termination connections, are located at a second end of the stator assembly opposite to the first end of the stator assembly.

### FIELD OF THE INVENTION

The present invention relates to a stator assembly for a brushless permanent magnet motor, and to a brushless permanent magnet motor comprising such a stator assembly.

### BACKGROUND OF THE INVENTION

There is a general desire to improve electric machines, such as brushless motors, in a number of ways. For example, improvements may be desired in terms of size, weight, power density, manufacturing cost, efficiency, reliability, and noise.

### SUMMARY OF THE INVENTION

According to a first aspect of the present invention there is provided a stator assembly for a brushless permanent magnet motor, the stator assembly comprising: a stator core; a plurality of coils wound around the stator core; and a plurality of termination connections to which the plurality of coils are connected; wherein a first subset of the plurality of termination connections are located at a first end of the stator assembly, and a second subset of the plurality of termination connections, different to the first subset of the plurality of termination connections, are located at a second end of the stator assembly opposite to the first end of the stator assembly.

Locating termination connections at opposing ends of the stator assembly may enable the stator assembly to have a smaller radial and/or axial dimension in comparison to a stator assembly in which the termination connections are located at a single end of the stator assembly. For example, where termination connections are located at a single end of the stator assembly, a greater radial and/or axial dimension of the stator assembly may be required in order to maintain sufficient creepage and clearance distances between the termination connections. In contrast, no such increase in radial and/or axial dimension may be required to accommodate a same number of termination connections in the stator assembly of the present invention by virtue of locating the first and second subsets of the termination connections at opposite ends of the stator assembly.

By minimising a radial and/or axial dimension of the stator assembly, a size of a brushless permanent magnet motor comprising the stator assembly may be minimised, which may provide for a minimised packaging volume for the brushless permanent magnet motor within an appliance.

Furthermore, locating termination connections at opposing ends of the stator assembly may facilitate manufacture of the stator assembly, for example by providing greater space for ease of access to the termination connections in comparison to an arrangement where all termination connections are located at a single end of the stator assembly.

The first and second subsets of the plurality of termination connections may comprise non-empty subsets of the plurality of termination connections, for example such that there is at least one termination connection in each of the respective first and second subsets of the plurality of termination connections.

The first subset of the plurality of termination connections may be smaller than the second subset of the plurality of termination connections. For example, the first subset of the plurality of termination connections may have a smaller cardinality than a cardinality of the second subset of the plurality of termination connections.

The first subset of the plurality of termination connections may comprise three termination connections, for example exactly three termination connections. The second subset of the plurality of termination connections may comprise six termination connections, for example exactly six termination connections.

The plurality of coils may be connected to the plurality of termination connections such that the stator assembly comprises a three-phase stator assembly for a three-phase brushless permanent magnet motor. Locating the termination connections at opposing ends of the stator assembly may be particularly suited to a three-phase stator assembly.

The plurality of coils may be connected, via the plurality of termination connections, in a star configuration. Locating the termination connections at opposing ends of the stator assembly may be particularly suited to a star configuration of the coils, for example by enabling a neutral connection of the star configuration to be located at an opposite end of the stator assembly to the live connections. The neutral connection may be at a different potential to that of the three phases of a star configuration. Spatially separating the neural connection from the three phases may reduce the number of potentials in close proximity to each other which must be isolated from each other. Thus having the neutral connection at an opposite end of the motor to the three phase connections may reduce the number of different potentials which must be isolated in a relatively small space.

The plurality of coils may be connected, via the plurality of termination connections, in a parallel star configuration. For example, where there are a plurality of coils per phase, coils of the same phase may be electrically connected in parallel with one another. Locating the termination connections at opposing ends of the stator assembly may be particularly suited to a parallel star configuration of the coils. For example, separating the termination connections in such a manner may provide sufficient spacing between termination connections to allow a minimal number of electrical connections to be made between the termination connections to provide a parallel star configuration of the coils. Providing a minimal number of termination connections may reduce a number of manufacturing operations needed to assemble the stator assembly, thereby reducing manufacturing time or cost, and may also minimise component count, which may lead to a reduced risk of failure.

The first subset of termination connections may comprise neutral termination connections, for example solely neutral termination connections. This may enable neutral termination connections to be separated from live termination connections, and may facilitate connection of the neutral termination connections, for example by providing clean line of sight between the neutral termination connections, enabling a relatively simple connection mechanism to be used.

The first subset of termination connections may be connected by a common neutral busbar, for example by a single common neutral busbar. This may provide a relatively simple connection mechanism. Use of a single common neutral busbar may reduce component count, which may reduce cost and/or reduce a risk of failure compared to an arrangement with multiple neutral busbars.

The second subset of termination connections may comprise live termination connections, for example solely live termination connections. This may enable live termination connections to be separated from neutral termination connections, and may facilitate connection of the live termination connections, for example by providing clean line of sight between the live termination connections, enabling a maximal access for a manufacturing tooling head to create the connections.

The second subset of termination connections may comprise a plurality of pairs of termination connections, each termination connection within a pair connected together by a live busbar. Use of busbars may provide a simpler connection mechanism than, for example, connecting the live termination connections using a track on a PCB, and may provide reduced cost and/or environmental benefits when compared to use of a track on a PCB.

Each pair of termination connections may correspond to a pair of coils, for example a pair of coils of a same phase.

Each live busbar may have substantially the same form, for example substantially the same shape and/or substantially the same dimensions. This may provide for ease of manufacture and may reduce a cost of manufacture compared to, for example, an arrangement where multiple forms of busbar are required.

Each live busbar may extend for substantially 180 degrees about a periphery of the stator assembly, for example with coils of the same phase located diametrically opposite one another in the stator assembly.

Each busbar may comprise a live input connection located substantially halfway along the busbar between the corresponding live termination connections. This may reduce a risk of imbalanced current flowing between coils of the same phase, for example where coils of the same phase are connected in parallel, which may otherwise result in recirculating currents that do not contribute to torque generation, and can result in radial loads on a rotor assembly which the stator assembly is used to drive in use.

The stator assembly may comprise a carrier to which the live busbars are mounted. This may provide increased stability during manufacture compared to, for example, a stator assembly absent such a carrier.

The plurality of termination connections may comprise pins extending axially from the respective first and second ends of the stator assembly. Termination connections extending axially from the first and second ends of the stator assembly may minimise a radial footprint of the stator assembly compared to, for example, termination pins extending radially outwardly of the stator assembly. This may minimise a packaging volume of the stator assembly in a radial direction. The termination connections may extend no further radially outwardly than an outer perimeter of the stator core and/or of an outer perimeter of the coils.

The first subset of the plurality of termination connections may be substantially evenly spaced about a periphery of the first end of the stator assembly. This may facilitate connection of the first subset of the plurality of termination connections.

The second subset of the plurality of termination connections may be substantially evenly spaced about a periphery of the second end of the stator assembly. This may facilitate connection of the second subset of the plurality of termination connections whilst maximising a distance between the termination connections from a creepage and/or clearance perspective.

The stator assembly may comprise a plurality of stator core assemblies, each stator core assembly comprising a stator core segment. By providing a segmented stator core, winding of the coils about the stator core may be reduced in cost and/or complexity compared to, for example a winding procedure for a full annular stator core. Furthermore, a higher copper fill factor may be achieved when compared with winding processes utilised for a full annular stator core.

The stator assembly may comprise three stator core assemblies, for example exactly three stator core assemblies. This may provide for easier winding of the coils about the stator core segments than, for example an arrangement where only two stator core assemblies, and hence two stator core segments, are utilised. For example, an arrangement with only two stator core segments may result in stator core segments spanning substantially 180 degrees each, which may provide reduced access for a winding machine to the interior of the curve defined by the stator core segment when compared to, for example curves of lower arc length. This may particularly be the case where each stator core assembly has exactly two coils.

Furthermore, for a three phase motor, having a multiple of three stator core assemblies may keep impedance and/or current balanced between the three phases. Three stator core assemblies is the minimum number of stator core assemblies that can achieve this, and may minimise any resultant increase in reluctance in the magnetic circuit due to the interfaces between the stator core assemblies when compared to a higher number multiple of three of stator core assemblies.

Each stator core assembly comprises a bobbin mounted to a respective stator core segment, at least one of the first subset of the plurality of termination connections mounted to each bobbin, and at least two of the second subset of the plurality of termination connections mounted to each bobbin. In such a way the termination connections may be distributed substantially evenly between the stator core assemblies.

Each stator core assembly may comprise two coils, and the two coils may be wound in opposite directions. As each stator core assembly comprises the same number of coils, with one coil wound in each direction, for example left-hand wound or right-hand wound, the stator core assemblies may be substantially similar in form, which may reduce a cost and/or complexity of a manufacturing process for the stator assembly compared to, for example, a stator assembly where different forms of stator core assembly are used.

The two coils may be wound using a single wire, for example using a continuous winding process. This may reduce cost and complexity of manufacture of the stator assembly compared to, for example, a stator assembly where individual wires are used to wind each coil.

Each stator core assembly may comprise substantially the same form. This may reduce cost and complexity of manufacture of the stator assembly compared to, for example, a stator assembly where different forms of stator core assembly are used.

The stator assembly may have an outer diameter of no more than 40 mm, for example no more than 35 mm, no more than 30 mm, no more than 25 mm, or no more than 20 mm. Locating termination connections at opposing ends of the stator assembly may enable such a size of stator assembly whilst maximising available distances for creepage and/or clearance for the plurality of termination connections.

The stator assembly may be overmoulded, for example overmoulded by an electrically insulating material such as a plastic material. This may allow for the termination connections with the first and/or second subsets to be closer to one another than an arrangement where no such overmoulding is present. The plastic material may comprise a filled plastic material, for example a plastic material comprising a filled intended to enhance the thermal conductivity when compared to the plastic material alone.

A second aspect of the present invention provides a brushless permanent magnet motor comprising a stator assembly according to the first aspect of the present invention.

The plurality of coils, when energised, may generate a magnetic field that interacts with a permanent magnet of a rotor assembly of the brushless permanent magnet motor to rotate the rotor assembly relative to the stator assembly.

The brushless permanent magnet motor may be configured to operate at around 400V, for example with the coils configured to receive a DC link voltage of around 400V.

According to a third aspect of the present invention there is provided a haircare appliance comprising a brushless permanent magnet motor according to the second aspect of the present invention.

According to a fourth aspect of the present invention there is provided a vacuum cleaner comprising a brushless permanent magnet motor according to the second aspect of the present invention.

Optional features of aspects of the present invention may be equally applied to other aspects of the present invention, where appropriate.

### BRIEF DESCRIPTION OF THE DRAWINGS

FIG. 1 is a perspective view of a stator assembly;

FIG. 2 is an exploded view of the stator assembly of FIG. 1;

FIG. 3 is a perspective view of a stator core assembly of the stator assembly of FIG. 1;

FIG. 4 is an exploded view of the stator core assembly of FIG. 3;

FIG. 5 is a perspective view of a first busbar assembly of the stator assembly of FIG. 1;

FIG. 6 is a perspective view of a live busbar of the first busbar assembly of FIG. 5;

FIG. 7 is a perspective view of a neutral busbar;

FIG. 8 is a schematic illustration of a brushless permanent magnet motor comprising the rotor assembly of FIG. 1;

FIG. 9 is a schematic illustration of a vacuum cleaner comprising the brushless permanent magnet motor of FIG. 6; and

FIG. 10 is a schematic illustration of a haircare appliance comprising the brushless permanent magnet motor of FIG. 1.

### DETAILED DESCRIPTION OF THE INVENTION

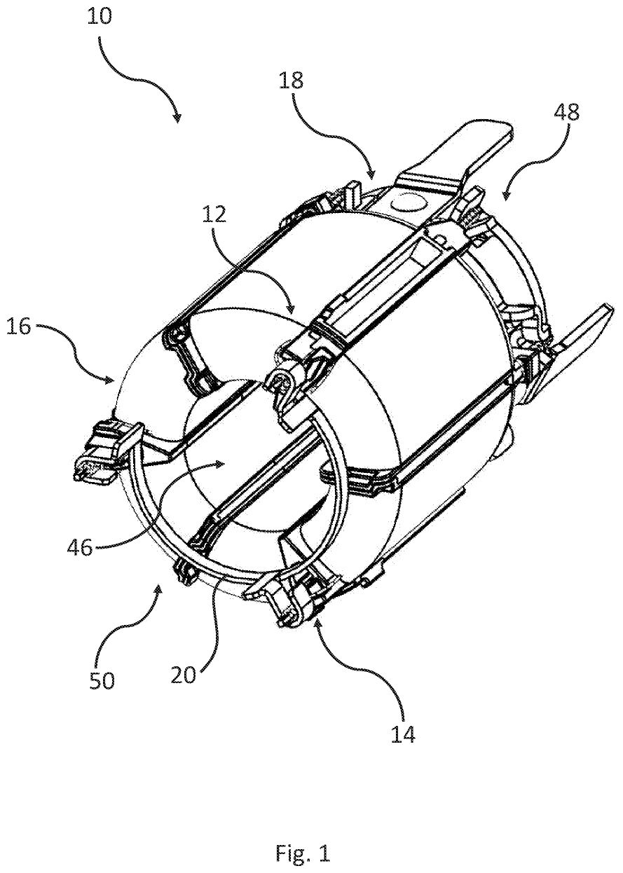

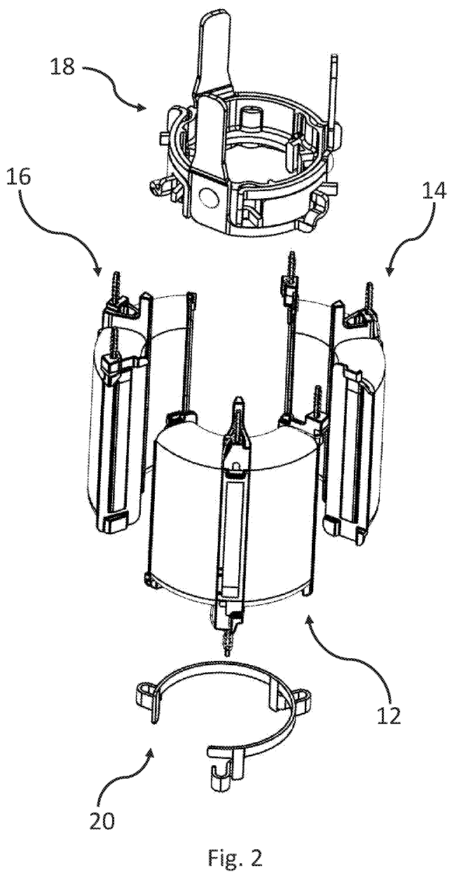

A stator assembly 10 is illustrated schematically in FIGS. 1 and 2, and comprises first 12, second 14 and third 16 stator core assemblies, and first 18 and second 20 busbar assemblies.

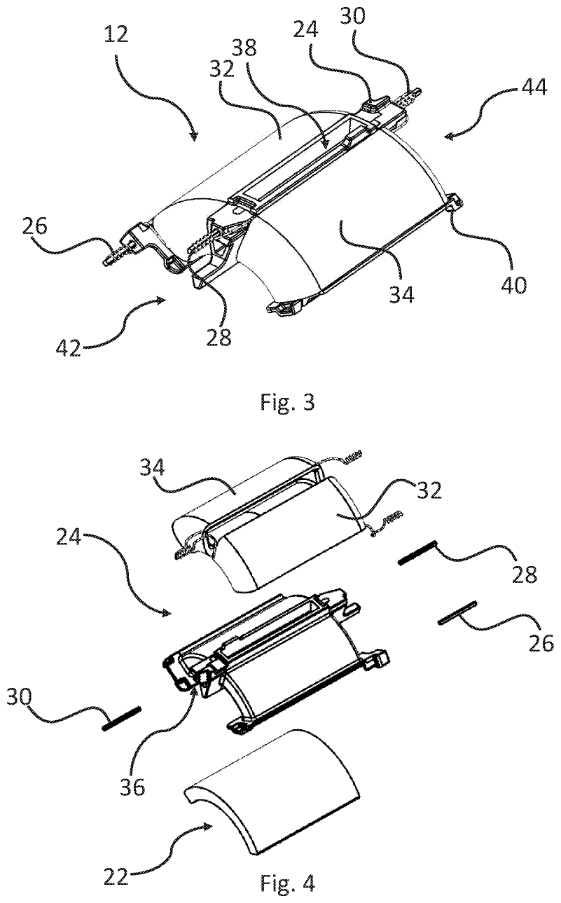

The first stator core assembly is shown in FIGS. 3 and 4. Each of the first 12, second 14, and third 16 stator core assemblies has substantially the same form, and so the second 14 and third 16 stator core assemblies will not be described in detail here for the sake of brevity. It will be appreciated that like reference numerals for features of the first stator core assembly 12 may be used for corresponding features of the second 14 and third 16 stator core assemblies.

The first stator core assembly 12 comprises a stator core segment 22, a bobbin 24, first 26, second 28, and third 30 termination connections, and first 32 and second 34 coils.

The stator core segment 22 is formed of a stack of steel laminations (not shown), and is generally arcuate in form, with a height greater than its length and width. The stator core segment 22 spans an arc length of substantially 120 degrees. Circumferential end faces of the stator core segment 22 are generally planar in form.

The bobbin 24 is formed of a plastics material, and is overmoulded onto the stator core segment 22. The bobbin 24 comprises connection recesses 36, a window 38, and connection features 40. The connection recesses 36 are generally cylindrical in form, and are shaped and dimensioned to receive the respective first through third termination connections 26-30. The window 38 is generally elongate and rectangular in cross-section, and provides line-of-sight to a radially outer face of the stator core segment 22. The window 38 enables an appropriate magnet to hold the stator core segment 22 in place during assembly of the first stator core assembly 12. The connection features 40 comprise appropriate projections and/or recesses that interact with corresponding recesses and/or projections of the second 14 and third 16 stator core assemblies to hold the stator core assemblies 12,14,16 relative to one another.

The first through third termination connections 26-30 have substantially the same form, and are generally elongate pins with a square cross-sectional shape, formed from an electrically conductive material. The first 26 and second 28 termination connections are inserted into respective connection recesses 36 with a push-fit, and extend axially outwardly from a first end 42 of the first stator core assembly 12. The third termination connection 30 is inserted into a respective connection recess 36 and extends axially outwardly from a second end 44 of the first stator core assembly 12 opposite to the first end 42 of the first stator core assembly 12.

The first 32 and second 34 coils are formed from turns of copper wire, and are wound about the bobbin 24 such that the first 32 and second 34 coils overlie radially inner and radially outer surfaces of the stator core segment 22. The stator assembly 10 is a slotless stator assembly. The first 32 and second 34 coils are represented in block form, such that individual turns are not visible, in the figures for the sake of clarity. The first 32 and second 34 coils are formed from a single piece of copper wire, such that the first 32 and second 34 coils are wound using a continuous winding process. For example, the first coil 32 being at the first termination connection 26, is wound about the bobbin 24, and hence the stator core segment 22, and tied off at the third termination connection 30. The second coil 32 then starts at the third termination connection 30, is wound about the bobbin 24, and hence the stator core segment 22, and tied off at the second termination connection 28. The first 32 and second 34 coils are wound in opposite directions, with one of the first 32 and second 34 coils being right-hand wound, and the other of the second 34 and first 32 coils being left-hand wound. Collectively, the first 12, second 14 and third 16 stator core assemblies, when connected together, define an annulus having a central bore 46 for receiving a rotor assembly, with the stator assembly 10 having a diameter of no more than 40 mm. When connected together the generally circumferential faces of the stator core segments 22 are substantially in contact with one another, such that a generally annular stator core is formed by the stator core segments 22. The first 26 and second 28 termination connections of each stator core assembly 12,14,16 form a first subset of termination connections located at first end 48 of the stator assembly 10, and the third termination connections 30 form a second subset of termination connections located at a second end 50 of the stator assembly 10.

The first 26 and second 28 termination connections are evenly spaced about a circumference of the first end 48 of the stator assembly 10, whilst the third termination connections 30 are evenly spaced about a circumference of the second end 50 of the stator assembly 10.

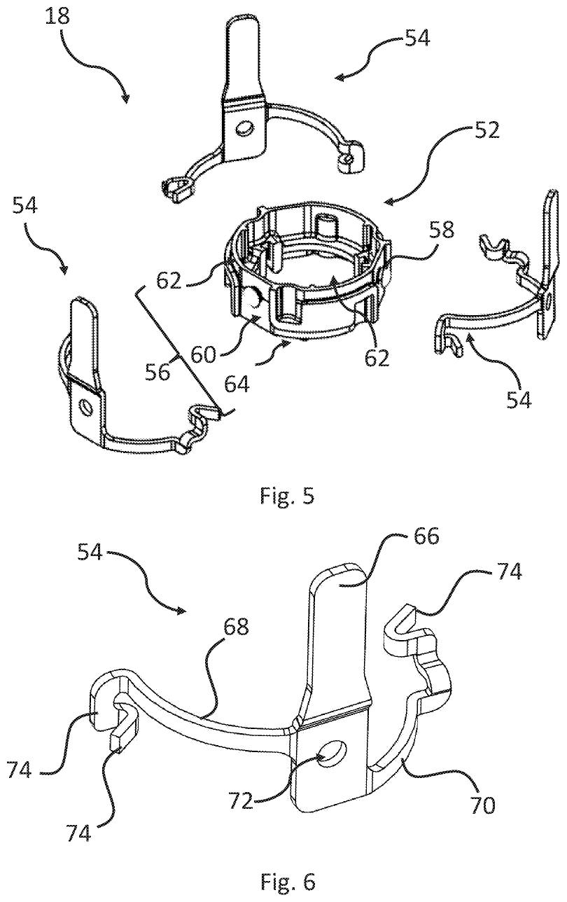

The first busbar assembly 18 is located at the first end 48 of the stator assembly 10, and is shown in isolation in FIG. 5. The first busbar assembly 18 comprises a carrier 52 and three live busbars 54.

The carrier 52 is generally annular in form, and is moulded from a plastics material. The carrier 52 comprises three channels 56 and three heat stakes 58. Each channel 56 has substantially the same form, is formed on a radially outer surface of the carrier 52, and has a central portion 60, an upper portion 62, and a lower portion 64. The central portion 60 extends axially along the carrier 52 in a height direction, whilst the upper portion 62 extends circumferentially from the central portion 60 in a first direction, and the lower portion 64 extends circumferentially from the central portion 60 in a second direction opposite to the first direction. The upper portion 62 of one channel 56 overlies a lower portion 64 of an adjacent channel 56 on the carrier 52. Each heat stake 58 is located in a corresponding central portion 60 of a channel 56.

A live busbar 54 is illustrated in isolation in FIG. 6. The live busbar 54 is formed of an electrically conductive material, and comprises a central portion 66, an upper portion 68, and a lower portion 70. The central portion 66 extends axially in a height direction, whilst the upper portion 68 extends circumferentially from the central portion 66 in a first direction, and the lower portion 70 extends circumferentially from the central portion 66 in a second direction opposite to the first direction. The central portion 66 defines a connection of the stator assembly 10 to an inverter (not shown), e.g. a live connection of the stator assembly that can receive a voltage in use. The central portion 66 comprises an aperture 72 for receiving a corresponding heat stake 58 of the carrier 52.

Each of the upper portion 68 and the lower portion 70 comprises connecting arms 74 extending in a direction parallel to the height of the central portion 66. The connecting arms 74 are substantially evenly spaced away from the central portion 66. The connecting arms 74 are welded to the first 26 and second 28 termination connections of each stator core assembly 12,14, 16 at the first end 48 of the stator assembly 10. Each live busbar 54 is thereby connected to two coils of the stator assembly.

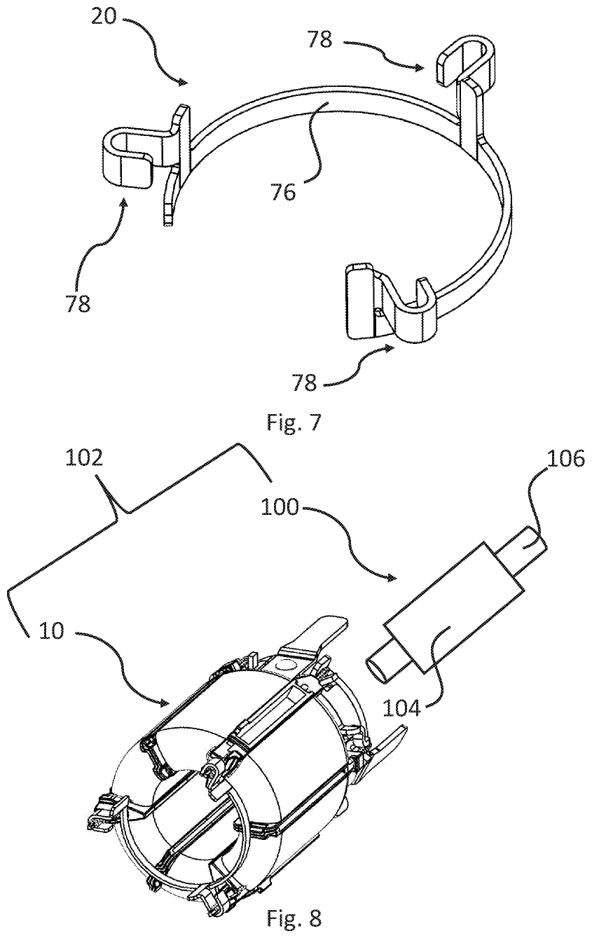

The second busbar assembly 20 is located at the second end 50 of the stator assembly 10, and is shown in isolation in FIG. 7. The second busbar assembly 20 comprises a single neutral busbar having a main body 76 and three connecting arms 78. The main body 76 is arcuate in form, and the three connecting arms 78 extend from the main body 76. The connecting arms 78 are welded to the third termination connections 30 of each stator core assembly 12,14,16 at the second end 50 of the stator assembly 10. Given that the first 32 and second 34 coils of each stator core assembly 12,14,16 are connected to the third termination connection 30 of that particular stator core assembly 12,14,16, and that a single neutral busbar is used to connect the third termination connections 30 together, each first 32 and second 34 coil of the stator assembly is connected together by the second busbar assembly 20.

In the manner described above, the coils 32,34 and the first 18 and second 20 busbar assemblies define a three-phase parallel star connection, with the first 26 and second 28 termination connections acting as live connections, and the third termination connections 30 acting as neutral connections.

Locating the first 26 and second 28 termination connections at an opposite end of the stator assembly 10 to the third termination connections 30 may enable the stator assembly 10 to have a smaller radial and/or axial dimension in comparison to a stator assembly in which the termination connections are located at a single end of the stator assembly. By minimising a radial and/or axial dimension of the stator assembly, a size of a brushless permanent magnet motor comprising the stator assembly 10 may be minimised, which may provide for a minimised packaging volume for the brushless permanent magnet motor within an appliance.

Furthermore, locating the termination connections at opposing ends of the stator assembly 10 in the manner described above may facilitate manufacture of the stator assembly 10 by providing greater space for ease of access to the termination connections in comparison to an arrangement where all termination connections are located at a single end of the stator assembly 10.

Manufacture of the stator assembly 10 may further be facilitated by use of the three stator core segments 22, each spanning an arc length of substantially 120 degrees. In particular, splitting the stator core into segments may enable the stator core segments 22 to be more linear than if a lower number of segments were utilised to form the annular stator core. This may facilitate formation of laminations that form the stator core segments 22, for example by enabling an increased number of laminations to be formed from a single sheet of material, reducing material wastage and cost.

Furthermore, an annular core or a two-part core with each segment spanning an arc length of 180 degrees may provide reduced access for a winding machine to the interior of the curve defined by the stator core segment when compared to, for example curves of lower arc length. Stator core segments of lower arc lengths may enable easier and/or less expensive winding processes to be utilised.

In use, the stator assembly 10 is paired with a rotor assembly 100 to form a brushless permanent magnet motor 102, as illustrated schematically in FIG. 8. The rotor assembly 102 comprises a shaft 104 and a permanent magnet 106 mounted to the shaft 104. When the coils 32,34 are driven with an appropriate voltage, here of up to around 400V, the stator assembly 10 generates a magnetic field that interacts with the permanent magnet 106 to rotate the rotor assembly 100.

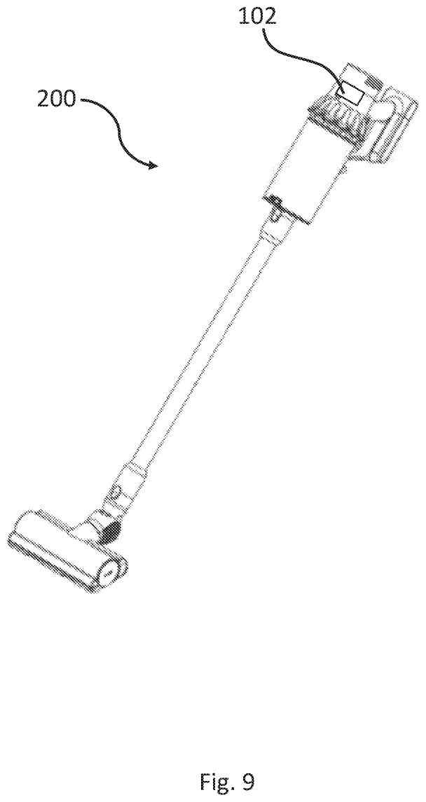

A vacuum cleaner 200 comprising the brushless permanent magnet motor 102 is illustrated schematically in FIG. 9.

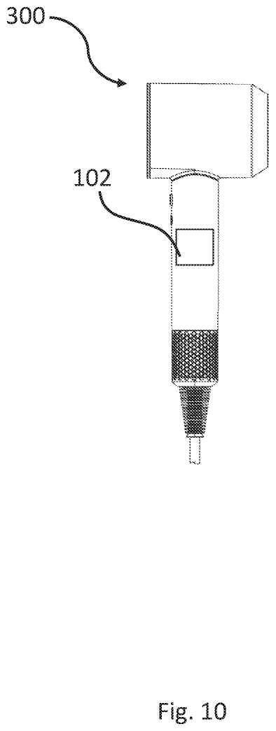

A haircare appliance 300 comprising the brushless permanent magnet motor 102 is illustrated schematically in FIG. 10.

1. A stator assembly for a brushless permanent magnet motor, the stator assembly comprising:
a stator core;
a plurality of coils wound around the stator core; and
a plurality of termination connections to which the plurality of coils are connected;
wherein a first subset of the plurality of termination connections are located at a first end of the stator assembly, and a second subset of the plurality of termination connections, different to the first subset of the plurality of termination connections, are located at a second end of the stator assembly opposite to the first end of the stator assembly.

2. A stator assembly as claimed in claim 1, wherein the plurality of coils are connected to the plurality of termination connections such that the stator assembly comprises a three-phase stator assembly for a three-phase brushless permanent magnet motor.

3. A stator assembly as claimed in claim 1, wherein the plurality of coils are connected, via the plurality of termination connections, in a star configuration.

4. A stator assembly as claimed in claim 1, wherein the plurality of coils are connected, via the plurality of termination connections, in a parallel star configuration.

5. A stator assembly as claimed in claim 3, wherein the first subset of termination connections comprise neutral termination connections.

6. A stator assembly as claimed in claim 5, wherein the first subset of termination connections are connected by a common neutral busbar.

7. A stator assembly as claimed in claim 3, wherein the first subset of termination connections comprise exactly three termination connections.

8. A stator assembly as claimed in claim 3, wherein the second subset of termination connections comprise live termination connections.

9. A stator assembly as claimed in claim 8, wherein the second subset of termination connections comprises a plurality of pairs of termination connections, each termination connection within a pair connected together by a live busbar.

10. A stator assembly as claimed in claim 9, wherein each live busbar has substantially the same form.

11. A stator assembly as claimed in claim 9, wherein the stator assembly comprise a carrier to which the live busbars are mounted.

12. A stator assembly as claimed in claim 1, wherein the plurality of termination connections comprise pins extending axially from the respective first and second ends of the stator assembly.

13. A stator assembly as claimed in claim 1, wherein the first subset of the plurality of termination connections are substantially evenly spaced about a periphery of the first end of the stator assembly.

14. A stator assembly as claimed in claim 1, wherein the second subset of the plurality of termination connections are substantially evenly spaced about a periphery of the second end of the stator assembly.

15. A stator assembly as claimed in claim 1, wherein the stator assembly comprises a plurality of stator core assemblies, each stator core assembly comprising a stator core segment.

16. A stator assembly as claimed in claim 1, wherein the stator assembly comprises three stator core assemblies.

17. A stator assembly as claimed in claim 15, wherein each stator core assembly comprises a bobbin mounted to a respective stator core segment, at least one of the first subset of the plurality of termination connections mounted to each bobbin, and at least two of the second subset of the plurality of termination connections mounted to each bobbin.

18. A stator assembly as claimed in claim 15, wherein each stator core assembly comprises two coils, and the two coils are wound in opposite directions.

19. A stator assembly as claimed in claim 15, wherein the two coils are wound using a single wire.

20. A stator assembly as claimed in claim 15, wherein each stator core assembly comprises substantially the same form.

21-25. (canceled)
